(19) United States
(12) Patent Application Publication
(10) Pub. No.: US 2006/0001353 A1
(43) Pub. Date: Jan. 5, 2006

(54) Flat fluorescent lamp

(75) Inventors: Xiaoqing Zeng, Gyeonggi-do (KR); Hyoung-bin Park, Gyeonggi-do (KR); Young-mo Kim, Gyeonggi-do (KR); Sang-hun Jang, Gyeonggi-do (KR); Hidekazu Hatanaka, Gyeonggi-do (JP); Seung-hyun Son, Gyeonggi-do (KR); Gi-young Kim, Gyeonggi-do (KR); Seong-eui Lee, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Gyeonggi-do (KR)

(21) Appl. No.: 11/092,560

(22) Filed: Mar. 29, 2005

(30) Foreign Application Priority Data
Jul. 5, 2004 (KR) 10-2004-0051966

(51) Int. Cl. H01J 1/62

(52) U.S. Cl. 313/487

(57) ABSTRACT

Provided is a flat fluorescent lamp that can emit white light composed of color components with enhanced color purity and/or white light having enhanced brightness and enhanced brightness uniformity. The flat fluorescent lamp includes a front substrate and a rear substrate separated from each other and defining a discharge space therebetween, a discharge gas filled in the discharge space and generating a first ultraviolet (UV) light with a wavelength of 260 nm or less by discharge of the discharge gas, at least a pair of electrodes inducing the discharge of the discharge gas, a second phosphor layer disposed on an inner surface of the rear substrate and including a phosphor excited by the first UV light and generating a second UV light having a wavelength of 200 to 400 nm which is longer than the wavelength of the first UV light, and a first phosphor layer disposed on an inner surface of the front substrate and including a phosphor excited by the first UV light and the second UV light and generating a visible light. Provided are also novel UV light-emitting phosphors excited by vacuum UV light and generating UV light.

### BACKGROUND OF THE INVENTION

Priority is claimed to Korean Patent Application No. 10-2004-0051966, filed on Jul. 5, 2004, in the Korean Intellectual Property Office, the disclosure of which is incorporated herein in its entirety by reference.

1. Field of the Invention

The present invention relates to a fluorescent lamp, and more particularly, to a flat fluorescent lamp.

2. Description of the Related Art

Flat fluorescent lamps are typically employed as backlights of liquid crystal displays (LCDs).

Since LCD panels do not have self-luminance property, LCDs require a separate optical source to display images. In this regard, LCDs generally include a liquid crystal panel, a driving circuit unit, and an optical source.

In early LCDs, a small lamp disposed on a front or lateral side had been used as an optical source. However, as a need for large area LCDs and high quality LCD images increases, there has been widely used a backlight disposed at the back of a liquid crystal panel and uniformly supplying light to the front surface of the liquid crystal panel. Preferably, it is required that a LCD backlight can uniformly supply a white light with high brightness to the front surface of a LCD.

As well known, fluorescent lamps have advantages of an extended life span and a low power consumption. In this respect, flat fluorescent lamps can be very efficiently used as backlights of LCDs. The flat fluorescent lamps can be classified into an opposite discharge type, a surface discharge type, or a combination type according to an electrode configuration.

FIG. 1 illustrates an exemplary sectional view of a conventional flat fluorescent lamp. The flat fluorescent lamp of FIG. 1 is a surface discharge type. Referring to FIG. 1, a front substrate 20 and a rear substrate 10 are separated from each other by a spacer 14. A discharge space 50 is defined by the front substrate 20 and the rear substrate 10. The discharge space 50 is filled with a discharge gas. For example, argon, neon, xenon, or a mixed gas is used as the discharge gas. A phosphor layer 30 is attached to each of a lower surface of the front substrate 20 and an upper surface of the rear substrate 10. The phosphor layer 30 may also be attached to a side of the spacer 14. First and second upper electrodes 22a and 22b are disposed on an upper surface of the front substrate 20. First and second lower electrodes 12a and 12b are disposed on a lower surface of the rear substrate 10. The same electric potential is applied to the first upper electrode 22a and the first lower electrode 12a. Therefore, discharge is not induced between the first upper electrode 22a and the first lower electrode 12a. Similarly, the same electric potential is applied to the second upper electrode 22b and the second lower electrode 12b, and thus, discharge is not induced between the second upper electrode 22b and the second lower electrode 12b. However, an electric potential difference is generated between the first upper electrode 22a and the second upper electrode 22b. An electric potential difference is also generated between the first lower electrode 12a and the second lower electrode 12b. Therefore, discharge is induced between the first upper electrode 22a and the second upper electrode 22b and between the first lower electrode 12a and the second lower electrode 12b in a parallel direction to the front substrate 20 and the rear substrate 10.

By the discharge induced in the above-described manner, the discharge gas is excited. The discharge gas thus excited emits a vacuum ultraviolet light. The vacuum ultraviolet light excites the phosphor layer 30, thereby emitting visible light. The visible light is emitted from the transparent front substrate 20. Generally, the phosphor layer 30 is made of a mixture of a phosphor excited by the vacuum ultraviolet light and generating red light, a phosphor excited by the vacuum ultraviolet light and generating green light, and a phosphor excited by the vacuum ultraviolet light and generating blue light. Therefore, the light emitted from the front substrate 20 is white light.

It is noted that the color purity of LCDs is significantly affected by the quality of white light emitted from a backlight. That is, the color purity of light passing through a color filter of a liquid crystal panel is dependent on the color purity of three colors (red, green, blue) constituting white light emitted from a backlight.

In a conventional flat fluorescent lamp, red, green, and blue phosphors contained in the phosphor layer 30 are excited by vacuum ultraviolet light. For example, (Y, Gd)BO₃:Eu is used as a red phosphor, LaPO₄:(Ce, Tb) is used as a green phosphor, and BaMgAl₁₀O₁₇:Eu is used as a blue phosphor. Generally, it has been evaluated that the purity of red, green, and blue colors of visible light emitted from these phosphors excited by vacuum ultraviolet light is not very good.

In this respect, a flat fluorescent lamp that can emit light composed of color components with improved color purity is still being required.

In the flat fluorescent lamp as shown in FIG. 1, it is also noted that visible light generated from the phosphor layer 30 attached to the upper surface of the rear substrate 10 is diminished while passing through the phosphor layer 30 attached to the lower surface of the front substrate 10. For this reason, the apparent luminance efficiency of the phosphor layer 30 attached to the upper surface of the rear substrate 10 is poorer than that of the phosphor layer 30 attached to the lower surface of the front substrate 10. This is responsible for a decrease of the brightness of the flat fluorescent lamp. In view of this problem, the phosphor layer 30 attached to the lower surface of the front substrate 10 can be formed to a very thin thickness. However, as the thickness of the phosphor layer 30 decreases, it becomes difficult to ensure thickness uniformity of the phosphor layer 30. When the thickness uniformity of the phosphor layer 30 is not ensured, uniformity of the brightness of visible light emitted from the front surface of the flat fluorescent lamp is lowered.

U.S. Pat. No. 6,559,598 B2 discloses a plasma picture screen including an ultraviolet (UV) light emitting layer. According to the plasma picture screen disclosed in the document, a red, green, and blue-emitting phosphor pattern is disposed on an upper surface of a rear substrate. For this reason, vacuum UV (VUV) light heading toward a front substrate cannot contribute to emission of visible light. According to a suggestion in the document, the UV light emitting layer excited by vacuum UV light and generating UV light is disposed on a lower surface of the front substrate. Therefore, vacuum UV light heading toward the front substrate is converted to UV light, which is then emitted toward the rear substrate. The emitted UV light is responsible for exciting the red, green, and blue-emitting phosphor pattern disposed on the upper surface of the rear substrate. As a result, the red, green, and blue-emitting phosphor pattern disposed on the upper surface of the rear substrate is excited by the vacuum UV light heading toward the rear substrate and the UV light emitted from the UV light emitting layer of the front substrate, thereby resulting in enhanced brightness.

However, the plasma picture screen disclosed in U.S. Pat. No. 6,559,598 B2 cannot be applied to a flat fluorescent lamp. This is because in the plasma picture screen disclosed in U.S. Pat. No. 6,559,598 B2, a phosphor layer emitting visible light is disposed on the rear substrate. Application of such a structure to a flat fluorescent lamp can significantly lower brightness.

Therefore, an improved flat fluorescent lamp that can provide visible light with enhanced brightness and brightness uniformity is still being required.

### SUMMARY OF THE INVENTION

Embodiments of the present invention provides a flat fluorescent lamp that can emit white light composed of color components with enhanced color purity and/or white light having enhanced brightness and enhanced brightness uniformity.

Embodiments of the present invention also provides a novel ultraviolet (UV) light-emitting phosphor that is excited by vacuum UV light and emits UV light.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view that illustrates an example of a conventional flat fluorescent lamp;

FIGS. 2 and 3 illustrate flat fluorescent lamps according to embodiments of the present invention;

FIG. 4 is an X-ray diffraction (XRD) analysis result of an exemplary ultraviolet (UV) light-emitting phosphor according to the present invention;

FIG. 5 is a graph that illustrates luminance characteristics of the phosphor of FIG. 4;

FIG. 6 is an XRD analysis result of another exemplary UV light-emitting phosphor according to the present invention;

FIG. 7 is a graph that illustrates luminance characteristics of the phosphor of FIG. 6;

FIG. 8 is an XRD analysis result of still another exemplary UV light-emitting phosphor according to the present invention;

FIG. 9 is a graph that illustrates luminance characteristics of the phosphor of FIG. 8;

FIG. 10 is a graph that illustrates luminance characteristics of red phosphors used in an embodiment of the present invention and a comparative embodiment;

FIG. 11 is a graph that illustrates luminance characteristics of green phosphors used in an embodiment of the present invention and a comparative embodiment;

FIG. 12 is a graph that illustrates luminance characteristics of blue phosphors used in an embodiment of the present invention and a comparative embodiment; and

FIG. 13 is a graph that illustrates color purities according to an embodiment of the present invention and a comparative embodiment.

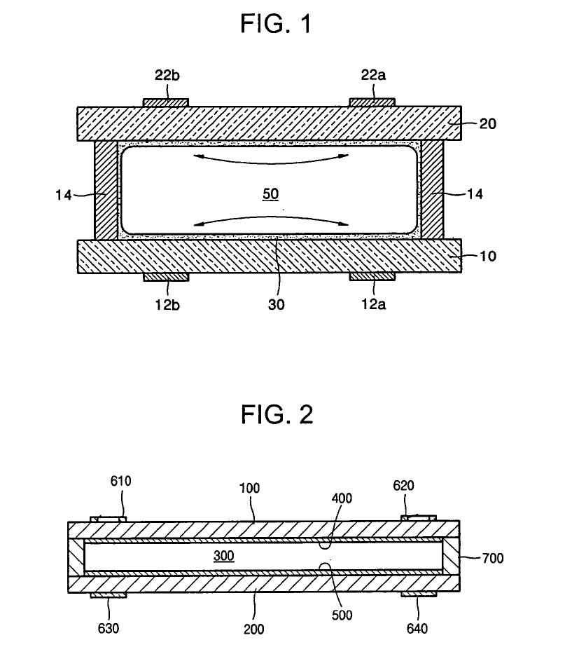

### DETAILED DESCRIPTION OF THE INVENTION

Exemplary embodiments of the present invention provide a flat fluorescent lamp, which includes:

a front substrate and a rear substrate separated from each other and defining a discharge space therebetween;

a discharge gas filled in the discharge space and generating a first ultraviolet (UV) light with a wavelength of 260 nm or less by discharge of the discharge gas;

at least a pair of electrodes inducing the discharge of the discharge gas;

a second phosphor layer disposed on an inner surface of the rear substrate and including a phosphor excited by the first UV light and generating a second UV light having a wavelength of 200 to 400 nm which is longer than the wavelength of the first UV light; and

a first phosphor layer disposed on an inner surface of the front substrate and including a phosphor excited by the first UV light and the second UV light and generating a visible light.

Generally, vacuum UV light refers to a light beam with a wavelength of about 200 nm or less and UV light refers to a light beam with a wavelength of about 200 to 380 nm. However, the terms “first UV light” and “second UV light” are used herein. The first UV light has a wavelength of about 260 nm or less (similar to that of vacuum UV light). The second UV light has a wavelength of about 200 to 400 nm (similar to that of UV light). The second UV light as used herein has a longer wavelength than the first UV light.

In exemplary embodiments of the flat fluorescent lamp of the present invention, a portion of the first UV light generated in the discharge space and heading toward the rear substrate is incident in the second phosphor layer and converted to the second UV light. The second UV light thus generated is emitted toward the front substrate and incident in the first phosphor layer. Of course, a portion of the first UV light generated in the discharge space and heading toward the front substrate is directly incident in the first phosphor layer. Therefore, in the flat fluorescent lamp according to this embodiment, visible light is generated only from the first phosphor layer excited by the first UV light and the second UV light.

An advantage of the above-described configuration is that the luminance efficiency of visible light induced by the portion of the first UV light generated in the discharge space and heading toward the rear substrate is higher than that in a conventional flat fluorescent lamp. As described above, in a conventional flat fluorescent lamp, a portion of a first UV light (or vacuum UV light) generated in a discharge space and heading toward a rear substrate excites a visible light-emitting phosphor disposed on the rear substrate, thereby generating visible light from the phosphor of the rear substrate. The visible light thus generated is transmitted through a phosphor layer disposed on a front substrate and then emitted from the fluorescent lamp. It is noted that when the visible light generated from the phosphor of the rear substrate is transmitted through the phosphor layer disposed on the front substrate, it is partially absorbed in the phosphor layer of the front substrate. However, in exemplary embodiments of the flat fluorescent lamp of the present invention, all visible light emitted from the flat fluorescent lamp is generated only from the first phosphor layer disposed on the front substrate. Therefore, the absorption phenomenon of visible light that is generated in a conventional technique is not involved in the flat fluorescent lamp of exemplary embodiments of the present invention. Consequently, the exemplary flat fluorescent lamp has an enhanced luminance efficiency of visible light, thereby ensuring an enhanced brightness.

Another advantage of the exemplary flat fluorescent lamp of the present invention is that the first phosphor layer can be disposed in a thicker thickness on the inner surface of the front substrate, thereby enhancing the thickness uniformity of the first phosphor layer. Consequently, the uniformity of visible light emitted from the flat fluorescent lamp of the present invention over the entire area of the front surface of the flat fluorescent lamp can be remarkably enhanced. In a conventional flat fluorescent lamp, it is common to minimize the thickness of a phosphor layer of a front substrate so that visible light generated from a phosphor of a rear substrate is efficiently transmitted through the phosphor layer of the front substrate. According to a common understanding, there is a trade-off relationship between the minimization of the thickness of a phosphor layer and the thickness uniformity of the phosphor layer due to the limit of the coating technology. When the thickness of the phosphor layer is minimized, the thickness uniformity of the phosphor layer is lowered. Therefore, the uniformity of visible light emitted from the front surface of a flat fluorescent lamp over the entire area of the front surface of the flat fluorescent lamp is lowered. However, in this exemplary flat fluorescent lamp of the present invention, visible light is emitted only from the first phosphor layer of the front substrate, and thus, there is no need to minimize the thickness of the first phosphor layer. In this exemplary flat fluorescent lamp of the present invention, the first phosphor layer having excellent thickness uniformity due to an appropriate thickness can be easily realized.

Still another advantage of this exemplary flat fluorescent lamp of the present invention is that the color purity of red, green, or blue component of visible light generated from the phosphor excited by the first UV light and the second UV light is more excellent, relative to that of visible light generated from a phosphor excited only by vacuum UV light like in a conventional flat fluorescent lamp. Therefore, when this exemplary flat fluorescent lamp of the present invention is used as a LCD backlight, the color purity of light passing through a color filter of a LCD panel can be remarkably enhanced.

Hereinafter, a flat fluorescent lamp according to exemplary embodiments of the present invention will be described in more detail.

Exemplary embodiments of the flat fluorescent lamp of the present invention include:

a front substrate and a rear substrate separated from each other and defining a discharge space therebetween;

a discharge gas filled in the discharge space and generating a first UV light with a wavelength of 260 nm or less by discharge of the discharge gas;

at least a pair of electrodes inducing the discharge of the discharge gas;

a second phosphor layer disposed on an inner surface of the rear substrate and including a phosphor excited by the first UV light and generating a second UV light having a wavelength of 200 to 400 nm which is longer than the wavelength of the first UV light; and

a first phosphor layer disposed on an inner surface of the front substrate and including a phosphor excited by the first UV light and the second UV light and generating a visible light.

The front substrate and the rear substrate are separated from each other by a predetermined distance. Therefore, a space is defined between the front substrate and the rear substrate. The space is filled with the discharge gas. For example, the discharge gas may be He, Ne, Xe, Kr, Hg, or a mixture thereof.

The first UV light generated by the discharge of the discharge gas may have a wavelength of about 260 nm or less. For example, when a mixed gas of Xe and He or Ne (e.g., the content of Xe is about 30% or more) is used as the discharge gas, the first UV light generated by the discharge of the discharge gas has a main wavelength of about 172 nm and a small part of 147 nm. [For example,] [w]When a mixed gas of Hg and an inert gas (He or Ne) (e.g., the content of Hg is several mg in a 4-feet fluorescent lamp) is used as the discharge gas, the first UV light generated by the discharge of the discharge gas has a main wavelength of about 254 nm.

In the flat fluorescent lamp of the present invention, a non-limiting example of the front substrate may be a glass plate. The front substrate has opposite two surfaces. Among the two surfaces, a surface exposed outside is referred to as an outer surface and an opposite surface to the rear substrate is referred to as an inner surface. The first phosphor layer is attached to the inner surface of the front substrate.

The first phosphor layer includes a phosphor which can be excited by the first UV light and the second UV light and generating visible light. The phosphor of the first phosphor layer may be a phosphor excited by the first UV light and the second UV light and generating red light, a phosphor excited by the first UV light and the second UV light and generating green light, a phosphor excited by the first UV light and the second UV light and generating blue light, or a mixture thereof. When the phosphor of the first phosphor layer is a mixture of a phosphor excited by the first UV light and the second UV light and generating red light, a phosphor excited by the first UV light and the second UV light and generating green light, and a phosphor excited by the first UV light and the second UV light and generating blue light, if the mixture ratio is appropriate, light generated from the first phosphor layer may be white light. In particular, when the first phosphor layer generates white light, exemplary embodiments of the flat fluorescent lamp of the present invention can be advantageously applied in the fields requiring white light, like a LCD backlight.

The phosphor excited by the first UV light and the second UV light and generating red light may be Y(P,V)O₄:Eu, YVO₄:Eu, Y₂O₂S:Eu, or the like. These phosphors may be used alone or in combination. These phosphors may be those known or commercially available.

The phosphor excited by the first UV light and the second UV light and generating green light may be BaMgAl₁₀O₁₇:(Eu,Mn), BaMgAl₁₄O₂₃:(Eu,Mn), BaMg₂Al₁₆O₂₇:(Eu,Mn), (Y,Gd)BO₃:(Ce,Tb), SrAl₂O₄:Eu, or the like. These phosphors may be used alone or in combination. These phosphors may be those known or commercially available.

The phosphor excited by the first UV light and the second UV light and generating blue light may be BaMgAl₁₀O₁₇:Eu, BaMgAl₁₄O₂₃:Eu, BaMg₂Al₁₆O₂₇:Eu, or the like. These phosphors may be used alone or in combination. These phosphors may be those known or commercially available.

In the flat fluorescent lamp of the present invention, a non-limiting example of the rear substrate may be a glass plate with a UV reflective layer such as an Al₂O₃ layer. The rear substrate has opposite two surfaces. Among the two surfaces, a surface exposed outside is referred to as an outer surface and an opposite surface to the front substrate is referred to as an inner surface. The second phosphor layer is attached to the inner surface of the rear substrate.

The second phosphor layer includes the phosphor excited by the first UV light and generating the second UV light. Examples of a phosphor excited by vacuum UV light and generating UV light include YBO₃:Bi, YBO₃:Gd, YBO₃:(Bi,Gd), YAl₃(BO₃)₄:Gd, LaPO₄:Pr, LaPO₄:(Pr,Gd), SrB₄O₇:Eu, Y₂GeO₅:Gd, LaPO₄:Ce, LaPO₄:(Ce,Gd), GdPO₄:Ce, LaMgAl₁₁O₁₉:Ce, SrB₄O₇:Eu, BaSi₂O₅:Pb, YMgB₅O₁₀:Ce, LaMgAl₁₁O₁₉:Ce, LaB₃O₆:Ce, and LaPO₄:Ce. These phosphors may be used alone or in combination. Among these phosphors, those except YBO₃:Bi, YBO₃:(Bi,Gd), and LaPO₄:(Pr,Gd) are known or commercially available. YBO₃:Bi, YBO₃:(Bi,Gd), and LaPO₄:(Pr,Gd) are new phosphors provided by the present invention and a detailed description thereof will be provided later.

For example, when the first UV light has a wavelength of 200 nm or less, it is more preferable that a phosphor generating the second UV light is YBO₃:Bi, YBO₃:Gd, YBO₃:(Bi,Gd), YAl₃(BO₃)₄:Gd, LaPO₄:Pr, LaPO₄:(Pr,Gd), SrB₄O₇:Eu, Y₂GeO₅:Gd, LaPO₄:Ce, LaPO₄:(Ce,Gd), GdPO₄:Ce, LaMgAl₁₁O₁₉:Ce, or a mixture thereof. For example, when the first UV light has a wavelength of 200 to 260 nm, it is more preferable that a phosphor generating the second UV light is SrB₄O₇:Eu, BaSi₂O₅:Pb, YMgB₅O₁₀:Ce, LaMgAl₁₁O₁₉:Ce, LaB₃O₆:Ce, LaPO₄:Ce, or a mixture thereof.

The flat fluorescent lamp of the present invention includes at least a pair of electrodes inducing the discharge of the discharge gas. There is no particular limitation to the configuration of the electrodes. For example, the configuration of the electrodes may be a coplanar arrangement (surface discharge type), a matrix arrangement (opposite discharge type), or one of various combinations thereof. The electrodes may be disposed on the inner or outer surface of the front substrate, the inner or outer surface of the rear substrate, or a combination thereof. The electrodes may be covered with a dielectric layer. The dielectric layer covering the electrodes may be covered with a protective layer. The dielectric layer may be made of SiO₂, PbO—SiO₂—B₂O₃, or ZnO—PbO—P₂O₅. The protective layer may be made of MgO.

In the exemplary flat fluorescent lamp, if the thickness of the first phosphor layer including the phosphor excited by the first UV light and the second UV light and generating visible light is too thin, the phosphor may be incompletely excited by the UV light, thereby lowering brightness. On the other hand, if it is too thick, transmission of visible light generated inside the flat fluorescent lamp may be difficult. Typically, the thickness of the first phosphor layer may ranges from about 15 to about 25 μm. It is noted that the first phosphor layer of the present invention can have a thickness appropriate to easily ensure thickness uniformity without lowering of brightness. In this regard, the thickness of the first phosphor layer may be more preferably from about 15 to 20 μm and still more preferably from about 18 to 20 μm.

In the exemplary flat fluorescent lamp of the present invention, if the thickness of the second phosphor layer including the phosphor excited by the first UV light and generating the second UV light is too thin, the phosphor may be incompletely excited by the first UV light, thereby lowering brightness. On the other hand, if it is too thick, the discharge space for the discharge gas may be excessively decreased or a capacitance or a discharge voltage may be increased. Typically, the thickness of the second phosphor layer may ranges from about 50 to 100 μm.

The first phosphor layer and the second phosphor layer may be respectively formed on the inner surfaces of the front substrate and the rear substrate by a dry coating process or a wet coating process. Examples of the dry coating process include electrostatic deposition and electrostatically supported dusting. Examples of the wet coating include dip coating, silk-screen printing, spin coating, meniscus coating, and blade coating. In the case of using a wet coating process, the phosphor is used in a dispersion form. A dispersion medium may be water, one of various organic solvents, or a mixture thereof. A phosphor dispersion may include a dispersant, a surfactant, an antifoaming agent, a binder, or a mixture thereof. The binder may be an organic binder or an inorganic binder. A wet-coated phosphor dispersion is subjected to thermal treatment. At this time, the dispersion medium, the dispersant, the surfactant, the antifoaming agent, and the organic binder are removed. The inorganic binder may also remain in the each phosphor layer after the thermal treatment.

An exemplary method of fabricating the flat fluorescent lamp of the present invention can be performed using any one of commonly known various methods, and thus, a detailed description thereof is omitted.

Hereinafter, several non-limiting embodiments illustrating the structure of the flat fluorescent lamp of the present invention will be described with reference to the accompanying drawings.

FIG. 2 illustrates a surface discharge type flat fluorescent lamp including two pairs of electrodes disposed on the outside of the flat fluorescent lamp. A first phosphor layer 400 is attached to an inner surface of a front substrate 100 and a second phosphor layer 500 is attached to an inner surface of a rear substrate 200. A discharge space 300 is defined between the front substrate 100 and the rear substrate 200. An electrode 610 and an electrode 620 are disposed on an outer surface of the front substrate 100. An electrode 630 and an electrode 640 are disposed on an outer surface of the rear substrate 200. The same electric potential is applied to the electrode 610 and the electrode 630. The same electric potential is applied to the electrode 620 and the electrode 640. An electric potential difference is generated between the electrode 610 and the electrode 620. An electric potential difference is generated between the electrode 630 and the electrode 640.

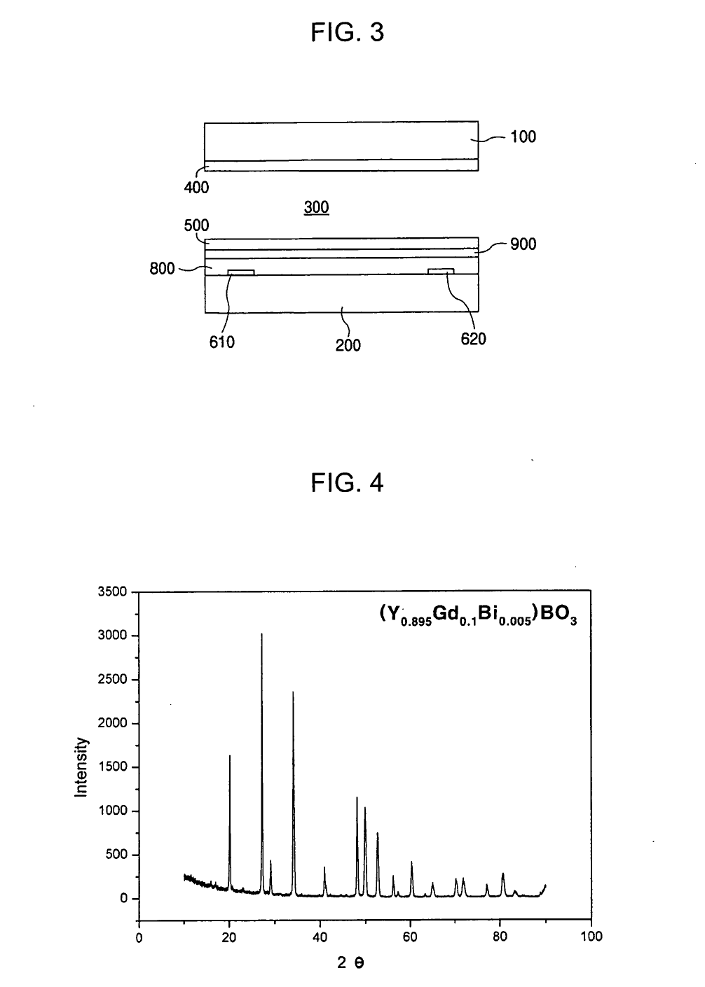

FIG. 3 illustrates a surface discharge type flat fluorescent lamp including a pair of electrodes disposed on the inside of the flat fluorescent lamp. A first phosphor layer 400 is attached to an inner surface of a front substrate 100. A discharge space 300 is defined between the front substrate 100 and a rear substrate 200. A second phosphor layer 500 is attached to an inner surface of the rear substrate 200. Electrodes 610 and 620, a dielectric layer 800, and a protective layer 900 are interposed between the rear substrate 200 and the second phosphor layer 500. The electrodes 610 and 620 are covered with the dielectric layer 800 and the dielectric layer 800 is covered with the protective layer 900. An electric potential difference is generated between the electrodes 610 and 620.

It will be understood by those of ordinary skill in the art that various changes in the structures of the flat fluorescent lamps as shown in FIGS. 2 and 3 may be easily made therein without departing from the spirit and scope of the present invention.

The present invention also provides novel UV light-emitting phosphors. The UV light-emitting phosphors of the present invention are YBO₃:Bi, YBO₃:(Bi,Gd), and LaPO₄:(Pr,Gd). These phosphors are efficiently excited by a first UV light and generate a strong second UV light.

### PREPARATION EXAMPLE 1

### YBO₃:(Bi,Gd)

15.16 g of Y₂O₃, 0.175 g of Bi₂O₃, 2.72 g of Gd₂O₃, and 10.23 g of H₃BO₃ were mixed using a ball mill. The reaction mixture was thermally treated in a 500° C. air atmosphere for two hours and then under a 1,100° C. air atmosphere for four hours. A product thus obtained was pulverized to make powders. These powders were five times washed with deionized water and dried at 100° C. for one day.

An X-ray diffraction (XRD) analysis for the resultant powders was performed and the result is shown in FIG. 4. From FIG. 4, it can be seen that the powders have a composition of (Y_{0.895}Gd_{0.1}Bi_{0.005})BO₃.

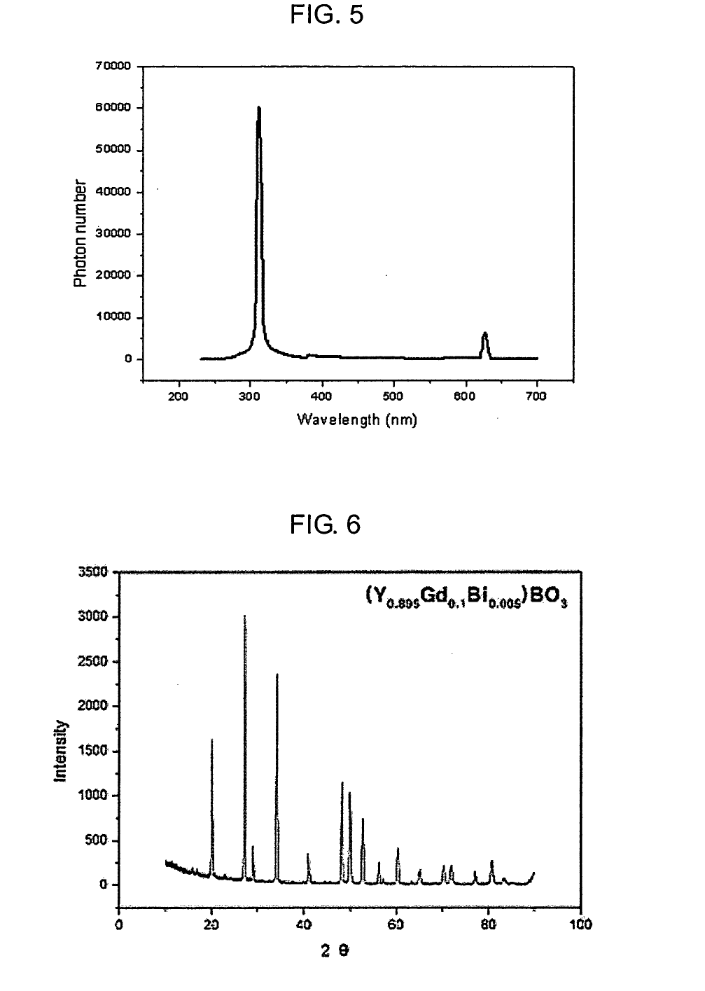

The luminance characteristics of the (Y_{0.895}Gd_{0.1}Bi_{0.005})BO₃ powders were analyzed by a spectrophotometer using an Xe excimer lamp as an optical source and the results are shown in FIG. 5. As shown in FIG. 5, the (Y_{0.895}Gd_{0.1}Fi_{0.005})BO₃ powders were efficiently excited by a 172 nm light beam under a 16 mtorr vacuum and generated a strong UV light of 313 nm wavelength.

### PREPARATION EXAMPLE 2

### YBO₃:Bi

16.85 g of Y₂O₃, 0.175 g of Bi₂O₃, and 10.23 g of H₃BO₃ were mixed using a ball mill. The reaction mixture was thermally treated in a 500° C. air atmosphere for two hours and then under a 1,100□ air atmosphere for four hours. A product thus obtained was pulverized to make powders. These powders were five times washed with deionized water and dried at 100□ for one day.

An XRD analysis for the resultant powders was performed and the result is shown in FIG. 6. From FIG. 6, it can be seen that the powders have a composition of (Y_{0.995}Bi_{0.005})BO₃.

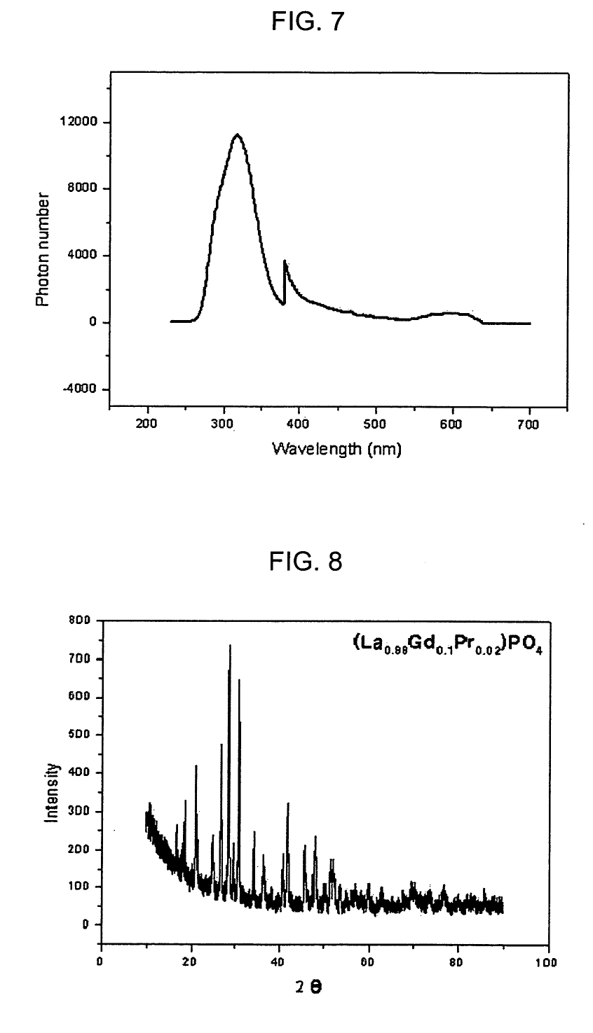

The luminance characteristics of the (Y_{0.095}Bi_{0.005})BO₃ powders were analyzed by a spectrophotometer using an Xe excimer lamp as an optical source and the results are shown in FIG. 7. As shown in FIG. 7, the YBO₃:Bi powders were efficiently excited by a 172 nm light beam under a 16 mtorr vacuum and generated a strong UV light of 313 nm wavelength.

### PREPARATION EXAMPLE 3

### LaPO₄:(Pr,Gd)

14.34 g of La₂O₃, 1.82 g of Gd₂O₃, 0.87 g of Pr(NO₃)₃.6H₂O, and 11.5 g of NH₄H₂PO₄ were mixed using a ball mill. The reaction mixture was thermally treated in a 500° C. air atmosphere for two hours and then under a 1,100° C. air atmosphere for four hours. A product thus obtained was pulverized to make powders. These powders were five times washed with deionized water and dried at 100° C. for one day.

An XRD analysis for the resultant powders was performed and the result is shown in FIG. 8. From FIG. 8, it can be seen that the powders have a composition of (La_{0.88}Pr_{0.02}Gd_{0.1})PO₄.

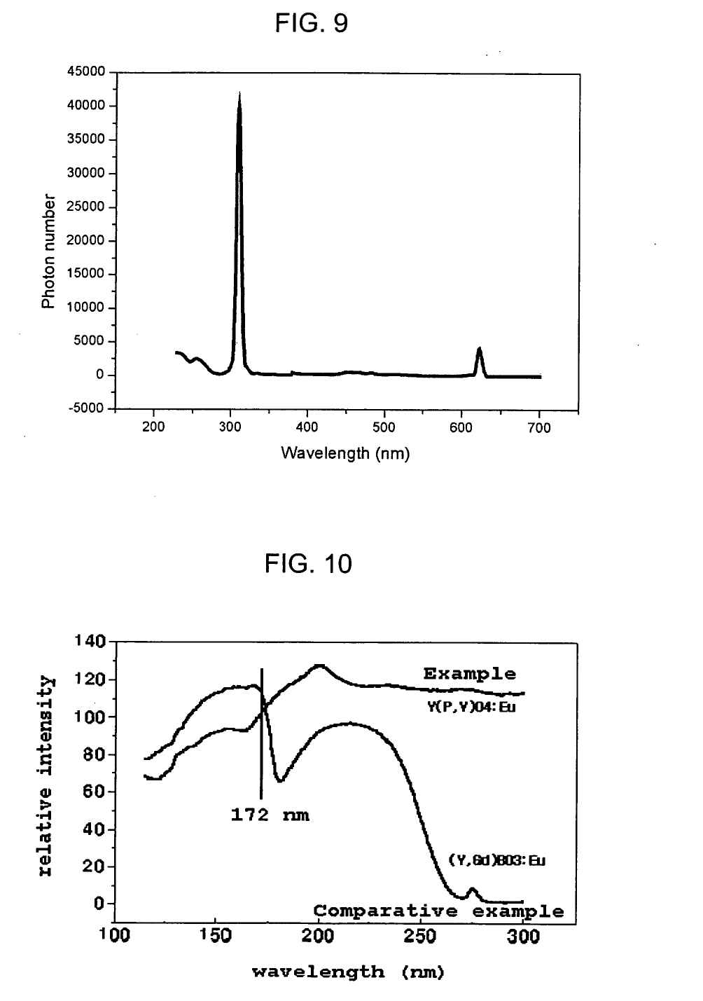

The luminance characteristics of the (La_{0.88}Pr_{0.02}Gd_{0.1})PO₄ powders were analyzed by a spectrophotometer using an Xe excimer lamp as an optical source and the results are shown in FIG. 9. As shown in FIG. 9, the (La_{0.88}Pr_{0.02}Gd_{0.1})PO₄ powders were efficiently excited by a 172 nm light beam under a 16 mtorr vacuum and generated a strong UV light of 320 nm wavelength.

In an embodiment of the present invention, a phosphor contained in a first phosphor layer may be a mixture of Y(P,V)O₄:Eu (red), BaMgAl₁₄O₂₃:(Eu,Mn) (green), and BaMgAl₁₀O₁₇:Eu (blue). These phosphors can be efficiently excited by first UV light and the second UV light and generate visible light. A mixture ratio of these phosphors can be appropriately selected so that visible light generated from the first phosphor layer is white light.

FIG. 10 shows a graph that illustrates the luminance characteristics of Y(P,V)O₄:Eu. In FIG. 10, the x-axis represents the wavelength of excitation light incident in a phosphor and the y-axis represents the relative intensity of-visible light generated from the phosphor excited by the excitation light. As shown in FIG. 10, Y(P,V)O₄:Eu was excited by a first UV light with a wavelength of about 260 nm or less and a second UV light with a wavelength of 200 to 400 nm and generated strong visible light. FIG. 10 also shows a graph that illustrates the luminance characteristics of (Y,Gd)BO₃:Eu which is a red phosphor widely used in a conventional flat fluorescent lamp as a comparative example. As seen from the curve of FIG. 10, (Y,Gd)BO₃:Eu was efficiently excited by a light beam with a wavelength of about 172 nm or less but not by a light beam with a wavelength of more than about 172 nm. According to embodiments of the present invention, the first UV light may have a wavelength of about 172 nm and the second UV light may have a wavelength of about 310 nm. In comparison at a wavelength of 172 nm, the luminance intensity of Y(P,V)O₄:Eu was somewhat smaller than that of (Y,Gd)BO₃:Eu. However, in comparison at a wavelength of 310 nm, the luminance intensity of Y(P,V)O₄:Eu was far stronger than that of (Y,Gd)BO₃:Eu. Therefore, when Y(P,V)O₄:Eu and (Y,Gd)BO₃:Eu were simultaneously excited both by a 172 nm light beam and a 310 nm light beam, the total luminance intensity of Y(P,V)O₄:Eu was far stronger than that of (Y,Gd)BO₃:Eu.

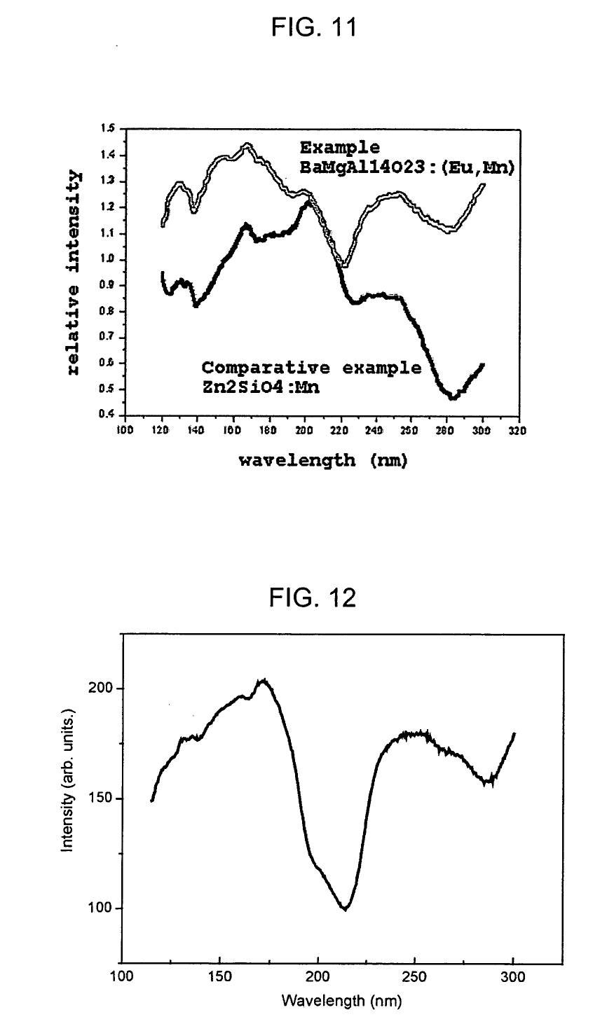

FIG. 11 shows a graph that illustrates the luminance characteristics of BaMgAl₁₄O₂₃:(Eu,Mn). In FIG. 11, the x-axis represents the wavelength of excitation light incident in a phosphor and the y-axis represents the relative intensity (defined by comparison with the luminance intensity of sodium salicylate) of visible light generated from the phosphor excited by the excitation light. As shown in FIG. 11, BaMgAl₁₄O₂₃:(Eu,Mn) was excited by first and second UV light and generated strong visible light. FIG. 11 also shows a graph that illustrates the luminance characteristics of Zn₂SiO₄:Mn which is a green phosphor widely used in a conventional flat fluorescent lamp as a comparative example. As seen from the curve of the FIG. 11, Zn₂SiO₄:Mn was efficiently excited only by a light beam with a wavelength of about 200 nm and not by a light beam with [other] longer wavelength range, in particular, a light beam with a second UV light wavelength. According to embodiments of the present invention, the first UV light may have a wavelength of about 172 nm and the second UV light may have a wavelength of about 310 nm. In comparison at a wavelength of 172 nm, the luminance intensity of BaMgAl₁40₂₃:(Eu,Mn) was far stronger than that of Zn₂SiO₄:Mn. In comparison at a wavelength of 310 nm, the luminance intensity of BaMgAl₁₄O₂₃:(Eu,Mn) was far stronger than that of Zn₂SiO₄:Mn. Therefore, when BaMgAl₁₄O₂₃:(Eu,Mn) and Zn₂SiO₄:Mn were simultaneously excited both by a 172 nm light and a 310 nm light, the total luminance intensity of BaMgAl₁₄O₂₃:(Eu,Mn) was far stronger than that of Zn₂SiO₄:Mn.

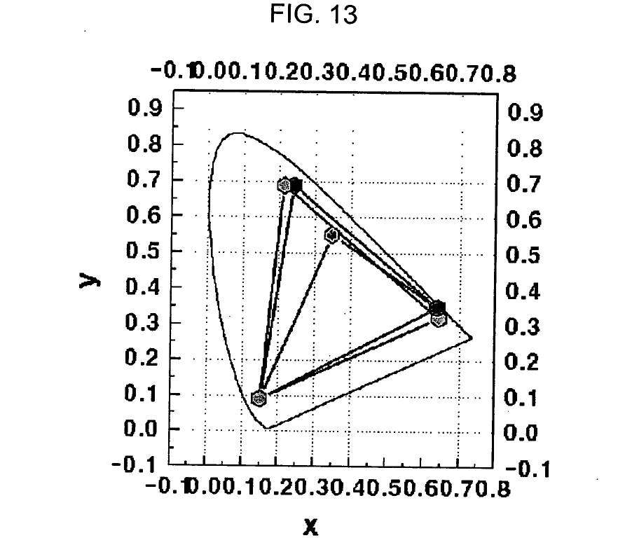

FIG. 12 shows a graph that illustrates the luminance characteristics of BaMgAl₁₀O₁₇:Eu. In FIG. 12, the x-axis represents the wavelength of excitation light incident in a phosphor and the y-axis represents the relative intensity of visible light generated from the phosphor excited by the excitation light. As shown in FIG. 12, BaMgAl₁₀O₁₇:Eu was excited by first and second UV light and generated strong visible light. BaMgAl₁₀O₁₇:Eu is also widely used as a [green] blue phosphor of a conventional flat fluorescent lamp. According to embodiments of the present invention, the first UV light may have a wavelength of about 172 nm and the second UV light may have a wavelength of about 310 nm. BaMgAl₁₀O₁₇:Eu was excited by a 172 nm light beam and a 310 nm light beam and generated very strong visible light.

Therefore, it can be seen that a flat fluorescent lamp including a first phosphor layer efficiently emitting light by first and second UV light according to the present invention can produce an enhanced brightness, relative to a conventional flat fluorescent lamp.

FIG. 13 illustrates a color purity (black hexagon) of visible light emitted from a flat fluorescent lamp including a first phosphor layer made of a mixture of Y(P,V)O₄:Eu (red), BaMgAl₁₄O₂₃:(Eu,Mn) (green), and BaMgAl₁₀O₁₇:Eu (blue), a second phosphor layer made of LaPO₄:(Pr,Gd), and a [70% Ne+30% Xe] discharge gas according to an embodiment of the present invention. FIG. 13 also illustrates a color purity (white hexagon) of visible light emitted from a conventional flat fluorescent lamp including a phosphor layer made of a mixture of (Y,Gd)BO₃:Eu (red), Zn₂SiO₄:Mn (green), and BaMgAl₁₀O₁₇:Eu (blue), and a [70% Ne+30% Xe] discharge gas as a comparative example.

From FIG. 13, it can be seen that the purity of red and green colors of the exemplary flat fluorescent lamp of the present invention was significantly enhanced, relative to that of the comparative example. Therefore, the color gamut of LCDs including the flat fluorescent lamp of the present invention as a backlight can be remarkably enhanced.

A flat fluorescent lamp of the present invention can produce an enhanced brightness since a visible light absorption phenomenon does not occur, unlike a conventional technique.

A first phosphor layer of the exemplary flat fluorescent lamp of the present invention can be a thickness appropriate to easily ensure thickness uniformity without lowering brightness, thereby ensuring the enhanced brightness uniformity of the flat fluorescent lamp.

The exemplary flat fluorescent lamp of the present invention can have more excellent color purity, as compared to a conventional flat fluorescent lamp having a color purity of visible light generated from a phosphor excited only by vacuum UV light.

What is claimed is:

1. A flat fluorescent lamp, which comprises:
a front substrate and a rear substrate separated from each other and defining a discharge space therebetween;
a discharge gas filled in the discharge space and generating a first ultraviolet (UV) light with a wavelength of 260 nm or less by discharge of the discharge gas;
at least a pair of electrodes inducing the discharge of the discharge gas;
a second phosphor layer disposed on an inner surface of the rear substrate and comprising a phosphor excited by the first UV light and generating a second UV light having a wavelength of 200 to 400 nm which is longer than the wavelength of the first UV light; and
a first phosphor layer disposed on an inner surface of the front substrate and comprising a phosphor excited by the first UV light and the second UV light and generating a visible light.

2. The flat fluorescent lamp of claim 1, wherein the phosphor of the first phosphor layer is a phosphor excited by the first and second UV light and generating red light, a phosphor excited by the first and second UV light and generating green light, a phosphor excited by the first and second UV light and generating blue light, or a mixture thereof.

3. The flat fluorescent lamp of claim 2, wherein the phosphor excited by the first and second UV light and generating red light is Y(P,V)O₄:Eu, YVO₄:Eu, Y₂O₂S:Eu, or a mixture thereof.

4. The flat fluorescent lamp of claim 2, wherein the phosphor excited by the first and second UV light and generating green light is BaMg₁₀O₁₇:(Eu,Mn), BaMgAl₁₄O₂₃:(Eu,Mn), BaMg₂Al₁₆O₂₇:(Eu,Mn), (Y,Gd)BO₃:(Ce,Tb), SrAl₂O₄:Eu, or a mixture thereof.

5. The flat fluorescent lamp of claim 2, wherein the phosphor excited by the first and second UV light and generating blue light is BaMg₁₀O₁₇:Eu, BaMgAl₁₄O₂₃:Eu, BaMg₂Al₁₆O₂₇:Eu, or a mixture thereof.

6. The flat fluorescent lamp of claim 1, wherein the phosphor of the second phosphor layer is YBO₃:Bi, YBO₃:Gd, YBO₃:(Bi,Gd), YAl₃(BO₃)₄:Gd, LaPO₄:Pr, LaPO₄:(Pr,Gd), SrB₄O₇:Eu, Y₂GeO₅:Gd, LaPO₄:Ce, LaPO₄:(Ce,Gd), GdPO₄:Ce, LaMgAl₁₁O₁₉:Ce, SrB₄O₇:Eu, BaSi₂O₅:Pb, YMgB₅O₁₀:Ce, LaMgAl₁₁O₁₉:Ce, LaB₃O₆:Ce, LaPO₄:Ce, or a mixture thereof.

7. The flat fluorescent lamp of claim 1, wherein the first UV light has a wavelength of 200 nm or less and the phosphor of the second phosphor layer is YBO₃:Bi, YBO₃:Gd, YBO₃:(Bi,Gd), YAl₃(BO₃)₄:Gd, LaPO₄:Pr, LaPO₄:(Pr,Gd), SrB₄O₇:Eu, Y₂GeO₅:Gd, LaPO₄:Ce, LaPO₄:(Ce,Gd), GdPO₄:Ce, LaMgAl₁₁O₁₉:Ce, or a mixture thereof.

8. The flat fluorescent lamp of claim 1, wherein the first UV light has a wavelength of 200-260 nm and the phosphor of the second phosphor layer is SrB₄O₇:Eu, BaSi₂O₅:Pb, YMgB₅O₁₀:Ce, LaMgA₁₁O₁₉:Ce, LaB₃O₆:Ce, LaPO₄:Ce, or a mixture thereof.

9. The flat fluorescent lamp of claim 1, wherein the first phosphor layer has a thickness of 15-25 μ.m

10. The flat fluorescent lamp of claim 1, wherein particles of the phosphors of the first and second phosphor layers have a protective film.

11. The flat fluorescent lamp of claim 1, wherein the first and second phosphor layers further include an inorganic binder.

12. The flat fluorescent lamp of claim 1, wherein the phosphor of the second phosphor layer is YBO₃:Bi, YBO₃:(Bi,Gd), LaPO₄:(Pr,Gd) or their combination.

13. A borate phosphor having the formula of YBO₃:Bi.

14. A borate phosphor having the formula of YBO₃:(Bi,Gd).

15. A phosphate phosphor having the formula of LaPO₄:(Pr,Gd).
